(19) United States
(12) Patent Application Publication
(10) Pub. No.: US 2021/0139631 A1
(43) Pub. Date: May 13, 2021

(54) PHENOLIC MOULDING MATERIAL

(71) Applicants: ALDINO ALBERTELLI, DUBLIN (IE); ROBERTO ZEDDA, DUBLIN (IE)

(72) Inventors: ALDINO ALBERTELLI, DUBLIN (IE); ROBERTO ZEDDA, DUBLIN (IE)

(21) Appl. No.: 16/618,647

(22) PCT Filed: May 31, 2018
(86) PCT No.: PCT/GB2018/051492

§ 371 Date: Dec. 2, 2019

(30) Foreign Application Priority Data
May 31, 2017 (GB) 1708688.5

(51) Int. Cl. C08G 8/10; B32B 5/18; B32B 27/06; B32B 27/42; B32B 27/40; C08K 3/36; C08K 3/22; C08K 3/40; C08K 7/14; C08K 3/26; C08K 13/04; C08J 5/24; C08J 9/42; C08L 61/06

(52) U.S. Cl. CPC C08G 8/10; C08L 2203/14; B32B 27/065; B32B 27/42; B32B 27/40; C08K 3/36; C08K 3/22; C08K 3/40; C08K 7/14; C08K 3/26; C08K 13/04; C08J 5/24; C08J 9/42; C08L 61/06; B32B 2266/06; B32B 2266/0278; B32B 2266/0285; C08K 2003/2227; C08K 2003/265; C08K 2201/014; C08J 2361/10; C08J 2461/10; C08J 2205/05; B32B 5/18

(57) ABSTRACT

The present invention is concerned with moulding materials for use in the formation of composites and is particularly concerned with phenolic composites. More specifically, the present invention is concerned with phenolic resin materials which can be used without the need to add catalyst materials, and which therefore do not suffer as readily as known compositions from discolouration.

The present invention is concerned with moulding materials for use in the formation of composites and is particularly concerned with phenolic composites. More specifically, the present invention is concerned with phenolic resin materials which can be used without the need to add catalyst materials, and which therefore do not suffer as readily as known compositions from discolouration.

The term “phenolic resin” describes a wide variety of resin based products that result from the reaction of phenols and aldehydes. Traditionally, phenolic resins are formed by reacting phenols with formaldehyde under either acidic or basic conditions, depending on the product required. When a phenolic resin is formed using a basic catalyst a thermosetting resin, or “resole”, is formed. Typical basic catalysts include hydroxides of alkali metals, such as sodium, potassium, or lithium. Alternatively, phenolic resins can be formed using an acid catalyst producing a pre-polymer (novolac) which can be moulded and subsequently cured.

Phenolic resins, and composite products comprising phenolic resins, are commonly used in a variety of applications, including consumer goods, machine parts, medical equipment, packaging, storage materials, thermal insulation, tiles, laminates, plywoods, foundry moulds, and furniture.

However, the resins produced using the above mentioned methods are known to darken on cure resulting in resins having a colour ranging from dark red to black. Due to this, only dark pigments can be used in combination with such resins, severely limiting the use/commercialisation of these materials within the above mentioned fields.

Accordingly, significant research has been undertaken to develop a method of controlling the extent of colour change during the formation of phenolic resins.

In particular, it is possible to mitigate the colour change effect of catalysts in phenolic resins by use of special equipment, pure raw materials and careful process control. However, such methods are known to be significantly increase costs compared to traditional methods, and do not alleviate the issue altogether.

An alternative method of controlling the colour change of the phenolic resins is to specially incorporate a specifically selected colour-stabilising agent.

For example, U.S. Pat. No. 3,005,798 discloses a method of improving the colour of phenol-formaldehyde resins by incorporating glyoxal into traditional acid or alkaline curing methods, thereby producing a yellow, straw-coloured, clear, transparent material. US '798 teaches that, in order to produce this effect, glyoxal must be incorporated in an amount of 0.2 to 1% by weight of the total phenol-formaldehyde solids. Preferably glyoxal is incorporated into the phenol resin whilst the phenol resin is still in water- soluble form, in order to aid dispersion of the compound throughout the resin.

U.S. Pat. No. 3,663,503 discloses a method of incorporating a colour-stabilising agent into the resin before cold curing the phenolic resin in the presence of a strong organic catalyst. US '503 teaches that the colour-stabilising agent is a thione compound present in amounts of about 0.2 to about 5% by weight of the resin. Suitable thione compounds may be selected from aliphatic and aromatic thiones, such as thioketones and thioesters, More specifically the thione compound maybe selected from thiourea and C═S containing derivatives of thiourea, diphenylthiourea, thiazolidine-2-thione, 2-thiobarbituric acid, and thiosemicarbazide. Furthermore, suitable strong organic catalysts to cure the phenolic resin include monochloroacetic acid, dichloroacetic acid, trichloroacetic acid, formic- and oxalic acid.

U.S. Pat. No. 4,369,259 teaches that the incorporation of phosphinic acid and phosphonic acid salts to phenolic resin mixtures provides increased resistance to colour changes due to light, air and/or heat. In particular, US '259 teaches that inorganic salts of phosphinic acid and phosphonic acid are used as stabilising agents and are present in amounts of at least 0.1%, preferably 0.3 to 1.0%, by weight of the finished foam. Examples of inorganic salts of phosphinic acids which may be used include alkali metal salts of the formula MeH₂PO₂.xH₂O. Furthermore, inorganic salts of phosphonic acids may be selected from alkali metals MeH₂PO₃ and Me₂HPO₃, wherein Me is sodium or potassium, and the corresponding calcium salts. US '259 teaches that the preferred curing agents are selected from aromatic sulphonic acids or hydrochloric acids.

In each case, the prior art teaches that in order to produce a phenolic resin with limited or reduced colour change, both a colour-stabilising agent and an acid catalyst must be present. Clearly, the requirement of both reactants will increase the costs of producing lighter coloured resins. Furthermore, as shown in some of the above mentioned documents, the colour stabilising agent may be required to be added at a specific point in the reaction process (i.e. whilst the phenol resin is still in water- soluble) in order to achieve the colour-stabilising effect throughout the resin formed. This creates a more complex reaction process, which will inevitably affects time efficiency and therefore, once again, cost efficiency of producing such resins.

In addition, many of the methods available for producing lighter coloured phenolic resins require the presence of strong acids or bases to catalyse the reaction process. It is known that the use of such chemicals causes corrosion of equipment which will therefore need to be replaced more frequently.

In view of the above, it is clearly desirable to produce a more cost efficient method of producing lighter coloured phenolic resins. It is also desirable to produce a simpler and more time efficient method of producing such resins. Finally, it is desirable to produce a method of forming lighter coloured phenolic resins which requires the use of fewer or no corrosive chemicals, such as acidic or basic catalysts.

In accordance with an aspect of the present invention, there is provided an uncured material for forming a phenolic resin sheet comprising:
1. uncured phenolic resin;
2. filler;
3. a catalyst in an amount of less than 2wt. % relative to the content of phenolic resin; and
   wherein the filler is present in a ratio of filler to uncured phenolic resin in an amount of 2.5:1 and greater, and further wherein the filler comprises a transition metal hydroxide and/or aluminium hydroxide in a ratio of metal hydroxide to uncured phenolic resin in an amount of 1:1.5 to 3:1.

It has been surprisingly found that the addition of a metal hydroxide compound within the filler allows for the amount of catalyst present to be significantly reduced, and even possibly avoided altogether.

Without wishing to be bound by any particular theory, it is believed that the addition of the metal hydroxide compound allows for the uncured phenolic material to reach an equivalent of B-stage curing (or what can also be considered as densification of the resin) without the need for a catalyst to be present in any significant quantity, or even at all.

As would be fully understood by persons of skill in the art, the B-stage (or densification) refers to a state (e.g. partially cured) which allows for increased processability of such phenolic resins, for example, allowing them to be formed into sheets which may then be applied to a substrate and/or surface. The stability is such that the formed sheets can be formed into rolls for storage and later use. Such materials can then be fully cured by the application of heat and pressure.

As discussed above in some detail, a problem with the use of traditional catalysts is the discolouration of the cured resin produced, and therefore the ability to produce composites of different colour finishes and patterns. By use of the material disclosed herein, it is possible to reduce or even alleviate such issues as the amount of catalyst can be used, and in some embodiments avoided altogether.

Preferably, the amount of catalyst that is present may be less than 1 wt. % relative to the content of the phenolic resin, more preferably less than 0.5 wt. % relative to the content of the phenolic resin, such as less than 0.2 wt. %.

In some embodiments, the uncured material may be substantially free of catalyst. By substantially free, it is meant that the amount of any catalyst present is negligible in terms of the overall effect that it has on uncured material, and its ability to reach a B-stage equivalent of curing.

Accordingly, a further aspect of the present invention provides an uncured material for forming a phenolic resin sheet consisting essentially of:
uncured phenolic resin; and
filler;
   wherein the filler is present in a ratio of filler to uncured phenolic resin in an amount of 2.5:1 and greater, and further wherein the filler comprises a transition metal hydroxide and/or aluminium hydroxide in a ratio of metal hydroxide to uncured phenolic resin in an amount of 1:1.5 to 3:1.

It will also be appreciated that the uncured materials disclosed herein may be free of catalyst.

For the avoidance of any doubt, the term catalyst is intended to refer to additives which are known to catalyse the curing of such phenolic resins, and are known to aid B-stage curing. Traditionally, such catalysts fall into two main categories, namely acidic and basic.

Examples of acidic catalysts include, but are not limited to, one or more of hydrochloric acid, sulphuric acid and oxalic acid.

Examples of basic catalysts include, but are not limited to, one or more of ammonia, sodium hydroxide, potassium hydroxide, lithium hydroxide, rubidium hydroxide, cesium hydroxide, barium hydroxide, calcium hydroxide and ethylamine.

It will also be appreciated that by reducing the presence of the catalyst material, or even avoided its presence altogether, it is possible to avoid discolouration issues without the need to add colour-stabilising agents, for example, glyoxal, thiones, phosphinic acid salts, phosphonic acid salts such as described above.

Accordingly, yet a further aspect of the present invention provides an uncured material for forming a phenolic resin sheet consisting of:
uncured phenolic resin;
filler;
optionally, further additives specifically as described herein; and
   wherein the filler is present in a ratio of filler to uncured phenolic resin in an amount of 2.5:1 and greater, and further wherein the filler comprises a transition metal hydroxide and/or aluminium hydroxide in a ratio of metal hydroxide to uncured phenolic resin in an amount of 1:1.5 to 3:1.

In accordance with the uncured materials described herein, the filler may be present in an amount of 3:1 and greater, and preferably in an amount of 3.5:1 and greater. It will be appreciated that the amount of filler which is added is dependent, in some instances on the intended use of the composite being prepared. It will also be appreciated that there is a significant economic advantage in being able to increase the amount of filler whilst still be able to meet the stringent requirements for such composites, such as strength, modulus, fire resistance, weathering resistance etc. Accordingly, the amount of filler present may also be in an amount of 5:1 and greater where applicable.

In accordance with the uncured materials described herein, the amount of filler may be present in an amount of 20:1 and less, such as in an amount of 10:1 and less.

The uncured phenolic compositions described herein are particularly concerned with phenol-formaldehyde resins.

In general, the fillers used in the uncured phenolic materials described herein may be any particulate solid which insoluble in the resin mixture.

As will be appreciated, it is preferable that the filler is inert to the rest of the uncured material.

The fillers used may be organic or inorganic materials. For some embodiments, it is preferable for the filler to be an inorganic material.

Suitable fillers for use in the uncured phenolic materials described herein may be selected from one or more of clays, clay minerals, talc, vermiculite, metal oxides, refractories, solid or hollow glass microspheres, fly ash, coal dust, wood flour, grain flour, nut shell flour, silica, ground plastics and resins in the form of powder, powdered reclaimed waste plastics, powdered resins, pigments, and starches.

As discussed above, it has been surprisingly found that the addition of a transition metal and/or aluminium hydroxide compound has the surprising effect of allowing the amount of catalyst to be greatly reduced and possibly avoided altogether.

Preferably, the transition metal or aluminium hydroxides are selected from compounds of formula M(OH)₃, wherein M is a metal.

Suitable metals (M) may be selected from one or more of scandium, vanadium, chromium, manganese, iron, cobalt and aluminium.

In a preferred embodiment, the metal hydroxide is aluminium hydroxide.

In the uncured materials described herein, the transition metal and/or aluminium hydroxide may be present in a ratio of metal hydroxide to uncured phenolic resin in an amount of 1:1.6 to 2.5:1, such as a ratio of metal hydroxide to uncured phenolic resin in an amount of 1:2 to 2:1.

In addition to the transition metal and/or aluminium hydroxide in the compositions described herein, the uncured phenolic material may further comprise ethylenediaminetetraacetic acid (EDTA). However, it is not in any way essential to the present inventions.

In preferred embodiments of the uncured materials described herein, the fillers do not substantially comprise silicates and/or carbonates of alkali metals. This is due to the fact that solids having more than a slightly alkaline reaction, for example silicates and carbonates of alkali metals, are preferably avoided because of their tendency to react with the acid hardener. However, solids such as talc, which have a very mild alkaline reaction, in some cases because of contamination with more strongly alkaline materials such as magnesite, are acceptable for use as fillers.

The thermoset material may include one or more release agents for aiding release of the thermoset material from the mould. Any suitable release agent may be used with the thermoset material according to the present invention. In preferred embodiments the release agent comprises a metal-fatty acid salt, for example a stearate salt. In preferred embodiments the release agent comprises zinc stearate, calcium stearate or magnesium stearate, preferably zinc stearate.

As discussed above, the use of the transition metal and/or aluminium hydroxide compound allows for the amount of catalyst used to be reduced, or even avoided altogether. A significant benefit of this is that issues known in the art associated with discolouration can be avoided, thus allowing for the use of pigments which previously would not have been suitable, especially for commercial uses where finishes are of great importance.

Suitable pigments may be selected from one or more of metal oxides, powdered paint, rock powders, glass and sand.

The finishes produced may vary according to type and colour, and may be controlled by the pigments used. For example, ground glass can be used to form a desirable texture. Alternatively, or in addition, the material may be coloured to give an attractive finish. Different colours or textures of finish may be used as required. Different coloured sands may be used to produce an attractive and realistic “brick” effect; different coloured sands may be used to produce an attractive pattern.

It will be understood that surface finishing effects may include, for example, brick, stone, marble, stucco, and slate.

It will also be understood that suitable colours may include white, yellow, pink, red, orange, green, blue, grey or purple. The reduction in catalyst and therefore the associated discolouration means that lighter colours may now be produced, for example, white, yellow, pink, red, orange, as well as light green, blue, grey and purple. The ability to produce finishes having such light colours greatly improves the commercial applications of such materials.

The uncured materials described herein may further comprise a viscosity controlling agent.

Suitable viscosity controlling agents may selected from one or more of butanol, chloroform, ethanol, water, acetonitrile, hexane, and isopropyl alcohol. In a preferred embodiment, the viscosity controlling agent is water.

It will be appreciated that the amount of viscosity controlling agent used is dependent on the intended use of the uncured material. Where the uncured material is to be formed into a sheet, it needs to be of a viscosity suitable for forming such a shape, for example, by an extrusion or rolling process. Likewise, where it is intended to impregnate a material, such as a woven fibre mat or textile, the viscosity must be such that the uncured material can flow around the fibres of the mat or textile and produce an impregnated material. It is considered that the controlling of the viscosity is within the knowledge of the person of skill in the art.

The uncured materials described herein may further comprise fibres.

The fibres may be short fibres, or may be longer fibres. The fibres may be loose, for example, the fibres may be arranged in a uni- or multi-directional manner. The fibres may be part of a network, for example woven or knitted together in any appropriate manner. The arrangement of the fibres may be random or regular.

Fibres may provide a continuous filament winding. More than one layer of fibres may be provided. The fibres may be in the form of a layer. Where the fibres are in the form of a layer, they may be in the form a fabric, mat, felt or woven or other arrangement.

In an embodiment, the fibres may be selected from one or more of mineral fibres (such as finely chopped glass fibre and finely divided asbestos), chopped fibres, finely chopped natural or synthetic fibres, and ground plastics and resins in the form of fibres.

In addition, the fibres may be selected from one or more of carbon fibres, glass fibres, aramid fibres and/or polyethylene fibres, such as ultra-high molecular weight polyethylene (UHMWPE).

The material may include short fibres. The fibres may of a length of 5 cm or less.

Where present, the fibres may be added to the uncured material in a ratio of resin to fibre of 6:1 to 1:3, such as a ratio of from 4:1 to 1:1.

The uncured phenolic material may be produced by mixing of the components as described above so as to form a generally homogeneous distribution of the components throughout the material. Any known method may be used to produce the general homogeneous distribution, such as high-shear mixing.

The length of time required to produce a generally homogeneous distribution of the components is dependent on, amongst other things, the amount of each component added, the viscosity of the components and the method of mixing used. In general, a substantially homogeneous distribution of the components can be formed within 5 minutes to 2 days, preferably within 10 minutes to 1 day, more preferably within 15 minutes to 10 hours.

In accordance with a further aspect of the present invention, there is provided a method of forming an uncured phenolic resin sheet comprising:
i. providing an uncured material as described herein above; and
ii. shaping the uncured material into a sheet.

Such a method may comprise the use of pressure, such as that provided by a press or rollers.

In an alternative method of forming of forming an uncured phenolic resin sheet, the method comprises:
i. providing an uncured material as described herein above;
ii. providing fibres as described herein above in the form of a layer; and
iii. applying a layer of the uncured material to the fibres.

Suitable methods of shaping the material into a sheet include the use of a series of compaction rollers, wherein the fibres are wetted with the uncured phenolic resin material. Furthermore, pressure applied by the compaction rollers ensures trapped excess air is removed. An upper and lower carrier film (e.g. polyethylene film) may b e applied to the sheet during formation, allowing the resulting sheet to be stored and used as required. The upper and lower carrier films can be removed before moulding. The general process of forming such a sheet is shown in FIG. 1.

Other suitable methods of moulding may include vacuum bag moulding, pressure bag moulding, autoclave moulding and resin transfer moulding.

The methods described above, allow for the production of an uncured phenolic resin sheet. As discussed above, an advantage of the material described herein is that it is able to form a B-stage cure equivalent without the need for significant amounts of catalyst (or even any catalyst). By forming such an equivalent, the material has desired processability, increasing its desirability for commercial use, especially as issues of discolouration can be avoided.

In particular, the sheets of the present invention can be stored in refrigerated chambers in order to improve shelf-life, and thus allow the uncured phenolic resin sheets to be cured at a later stage, as required. As the sheets can be readily supplied, it is unnecessary for users to have knowledge of and/or stock various resins, hardeners and reinforcement materials which would otherwise be required.

A further benefit of the sheets of the present invention is that it enables to two or more sheets to be aligned (including stacked and/or layered) before curing, in order to improve the mechanical properties of the resulting product.

Further still, such sheets can be cut into irregular shapes, thus simplifying manufacturing processes.

Even further still, two or more pieces of a sheet, or two or more sheets themselves, can be bonded together during the curing process, minimising material wastage resulting from such manufacturing methods. The sheets formed may have a thickness of from 1 mm to 50 mm, such as from 2 mm to 30 mm, or even 3 mm to 20 mm. Sheets of thickness 4 mm to 15 mm and 5 to 10 mm are also envisaged, as are sheets of 6 mm to 8 mm.

In addition, the phenolic material of the present invention (including in sheet form) present an alternative to SMC, which has traditionally been used to date. It has been found that the sheets of the present invention have the following advantages over SMC:
Better temperature performance and thermal shock resilience
   The phenolic materials of the present invention can be used to form brake pads, foundry molds, aerospace heat shields etc.
Excellent resistance to chemicals, corrosives / solvents, oil and water/salt water (including acid rain)
   The phenolic materials of the present invention can be used to make laboratory countertops
Improved fire, smoke and toxicity performance
   The phenolic materials of the present invention can be used in mass transport and defense applications
Improved anti-microbial properties
Harder, stronger, excellent dimensional stability
Electrical resistance
Good thermal insulation
Superior workability
Low temperature processing

In accordance with a further aspect of the invention, there is provided a method of forming a composite product comprising the steps of:
i. providing an uncured phenolic resin material as described herein above, or an uncured phenolic resin sheet described herein above;
ii. providing a substrate;
iii. applying a layer of the uncured phenolic resin material or uncured phenolic resin sheet onto a surface of the substrate; and
iv. pressing the layer of the uncured phenolic resin material or uncured phenolic resin sheet to the substrate such that at least a portion of the of the uncured phenolic resin material or uncured phenolic resin sheet bonds to the substrate.

The method may further comprise the step of causing or allowing the uncured phenolic resin material or uncured phenolic resin sheet to at least partially set.

The method may also further comprise the step of causing or allowing the phenolic resin material or uncured phenolic resin sheet to at least partially set by heating the phenolic resin material or uncured phenolic resin sheet to a suitable temperature.

By way of example, the phenolic resin material or uncured phenolic resin sheet may be heated to a temperature of at least 50° C. In some embodiments, the phenolic resin material or uncured phenolic resin sheet may be heated to a temperature of between 100 and 200° C.

By way of further example, the phenolic resin material or uncured phenolic resin sheet may be heated for a time period of at least one minute. In general, it will be appreciated that the time necessary to obtain the desired technical effect will depend on the amount of resin, the temperature, as well as the thickness of the material to be cured.

The substrate may be any suitable material.

The substrate may include surface formations for keying with the phenolic resin material. This can improve the bond between the substrate and the phenolic resin material.

The substrate may be formed from natural materials such as wood and cellulose derived products.

The substrate may also be formed from well-known polymeric materials such as polyvinylchloride, polyurethane, polyethylene, polystyrene, phenolics, syntactic polymers and honeycombs.

The substrate materials used may be foamed or unfoamed.

The foam substrate materials may be a crushable material such that, during the application of pressure, the surface of the substrate is moulded.

Preferred foamed materials include foamed phenolic resin or foamed polyurethane resin.

Where the material is foamed it may be open-celled or close-celled.

In a particularly preferred embodiment, the material is an open-cell foam.

Suitable open-cell foams include foamed phenolic resin for example, as manufactured under the brand Acell by Acell Industries Limited.

A particular advantage of using such an open-celled material is that during the pressing step at least a portion of the uncured phenolic resin material or uncured phenolic resin sheet flows into the open-cells of the substrate.

It will be appreciated that the application of heat may improve the flow of uncured phenolic resin material or uncured phenolic resin sheet flows into the open-cells of the substrate.

Preferably the uncured phenolic resin material or uncured phenolic resin sheet and substrate are such that the material only partly flows into the substrate during the pressing step so that good bonding between the uncured phenolic resin material or uncured phenolic resin sheet and the substrate is obtained while retaining a suitable uncured phenolic resin material or uncured phenolic resin sheet thickness for the required mechanical and other properties of the composite formed.

A further advantage with the use of an open-celled substrate material is that gas and/or vapour can be displaced from the pressing region. Preferably the pressing region is that area where the surface of the substrate and the uncured phenolic resin material or uncured phenolic resin sheet are being pressed together, preferably in the region of the interface of the substrate and the material.

By removing gas or vapour that might otherwise remain and/or build up in that region, it has been found that the pressure required to form the composite product can be significantly reduced in some examples.

Removal of gas or vapour from the region also aids in the formation of stronger bonds and prevents imperfections which may arise as a result of pressure build-up in a particular region. This can reduce the risk of delamination of the uncured phenolic resin material or uncured phenolic resin sheet material from the substrate in the final product, and provide a stable product when exposed to heating/cooling cycles.

Preferably the nature of the surface of the substrate is such that the gas or vapour can escape from the can escape from the pressing region in a direction having at least a component in a direction generally transverse to the pressing direction in which the uncured phenolic resin material or uncured phenolic resin sheet is pressed to the substrate.

Other formations (as an alternative or in addition) may be provided to assist the displacement of the gas. For example, grooves or channels could be formed in the substrate.

The configuration of the substrate which allows for the displacement of the gas may be inherent in that it arises from the nature of the composition of the substrate itself, and/or it may be provided by subsequent action, for example by machining the substrate or by chemical action on the substrate. Preferably the configuration of the substrate is such that it can release pressure in the pressing region.

The method of forming a composite product allows for the bonding of the uncured phenolic resin material or uncured phenolic resin sheet to the substrate during the pressing step. Such a bonding step may take place in the absence of an adhesive, particularly where keying and/or flow into open-cells within the substrate is possible.

Alternatively, or in addition, an adhesive or other bonding agent may be used between the substrate and the uncured phenolic resin material or uncured phenolic resin sheet.

Preferably, the uncured phenolic resin material or uncured phenolic resin sheet is applied to substantially all of the substrate.

The substrate itself may be shaped prior to the step of pressing the uncured phenolic resin material or uncured phenolic resin sheet to the substrate.

In addition, or alternatively, the pressing step may involve the use of a shaped mould, and therefore shaping may occur during the pressing step.

During the pressing step, a pressure of at least 400 Pa may be applied. Suitable pressures include those of between 500 and 7,000 Pa.

It will also be appreciated that given the nature of the uncured phenolic material, and the ability to control its viscosity, it is also possible to form a composite in situ. Such a method may comprise the steps of:
i. providing a substrate;
ii. providing fibres, such as a layer of fibres as described herein above;
iii. providing an uncured phenolic resin material as described herein above;
iv. applying the fibres to a surface of the substrate;
v. applying a layer of the uncured phenolic resin material onto the fibres; and
vi. pressing the uncured phenolic resin material and the fibres to the substrate so as to form a composite.

Yet a further aspect of the present invention is directed to a method of forming a phenolic skin, the method comprising the steps of:
i. providing a layer of uncured phenolic resin material as described herein above, or an uncured phenolic resin sheet described herein above; and
ii. curing the layer of the uncured phenolic resin material or uncured phenolic resin sheet.

The method of forming the phenolic skin may further comprise a shaping step so as to form a desired profile.

The shaping step may be undertaken by use of a mould, and involve the application of pressure, such as provided by a press. Additional moulding methods may include those described above.

Alternatively, it will be appreciated that such phenolic skins may be cut, shaved, chamfered or otherwise profiled after curing.

In yet another aspect of the present invention, there is provided a product formed from an uncured phenolic resin material or uncured phenolic resin sheet such as described herein.

Such a product may be formed using any of the processes described herein, or by other methods known to persons of skill in the art.

Products may include doors, windows, wall panels, counters, floors, ceiling panels, fences, roof panels, tiles, sidings and other structural products. The products may also include domestic items such as furniture. Other products which may be formed include car dashboards.

The products formed may be of any desired colour, such as white, yellow, pink, red, orange, green, blue or purple, including lighter shades of such colours.

In addition, surface effects may be added to the products. By way of example, suitable processes for adding such surface effects are described in WO2010/046699 and WO2010/046698, both in the name of Acell Holdings Limited.

The present invention will now be described by way of the following examples, together with the accompany figures in which:

FIG. 1 is a general process for forming an uncured phenolic resin sheet in accordance with the present inventions.

### EXAMPLES

The present examples illustrate the both the colour variation and strength of phenolic resins which can be produced in accordance with the present invention in comparison with SMC compounds of the prior art.

### Example 1

A phenolic resin paste was formed according to the composition shown in Table 1 by use of a mechanical mixer until such time that the components appeared to be homogeneously combined.

TABLE 1

| | Weight (Kg) | Wt. % |
|---|---|---|
| Phenolic resin | 1 | 28.29 |
| Grey sand | 1.6 | 45.26 |
| Al(OH)₃ | 0.9 | 25.46 |
| C₃₆H₇₀O₄Zn | 0.015 | 0.42 |
| Black Iron oxide | 0.02 | 0.57 |
| Total | 3.535 | 100 |

In addition, chops of glass fibers were added in a ratio of 2:1 resin to fibres, so as to mimic the amount of glass fibres in SMC.

Once formed the uncured resin material was rolled into a 3 mm thick sheet and allowed to rest overnight.

In order to produce a composite the uncured resin sheet was cut to produce a square 30 cm×30 cm, which was placed on an open-celled phenolic substrate (Acell foam sold by Acell Holdings Limited) of dimensions 30 cm×30 cm×3 cm.

The assembled materials were placed in a press and heated and pressed to cure the phenolic sheet.

The resulting composite panel was grey in colour.

### Example 2

A phenolic resin paste was formed according to the composition shown in Table 2 by use of a mechanical mixer until such time that the components appeared to be homogeneously combined.

| | Weight (Kg) | Wt % |
|---|---|---|
| Phenolic resin | 1 | 34.25 |
| Marble powder | 1.2 | 41.10 |
| Al(OH)₃ | 0.6 | 20.55 |
| C₃₆H₇₀O₄Zn | 0.01 | 0.34 |
| TiO₂ | 0.11 | 3.77 |
| Total | 2.92 | 100 |

In addition, chops of glass fibers were added in a ratio of 2:1 resin to fibres, so as to mimic the amount of glass fibres in SMC.

The process used to form the composite was identical to that used in Example 1.

The resulting composite panel was white in colour.

### Example 3

A phenolic resin paste was formed according to the composition shown in Table 3 by use of a mechanical mixer until such time that the components appeared to be homogeneously combined.

TABLE 3

| | Weight (Kg) | Wt % |
|---|---|---|
| Phenolic resin | 1 | 24.90 |
| Grey sand | 1.6 | 39.84 |
| Al(OH)₃ | 1.2 | 29.88 |
| C₃₆H₇₀O₄Zn | 0.022 | 0.55 |
| Black Iron oxide | 0.194 | 4.83 |
| Total | 3.535 | 100 |

In addition, chops of glass fibers were added in a ratio of 2:1 resin to fibres, so as to mimic the amount of glass fibres in SMC.

Further, 1 litre of water was added to the mixture during preparation as the viscosity of the mixture was higher than that in Examples 1 and 2. The water was added as a viscosity controlling agent.

The process used to form the composite was identical to that used in Example 1, with the exception was the water was allowed to evaporate from the sheet prior to processing so that its final viscosity (before processing) was similar to that of Examples 1 and 2.

The resulting composite panel was black in colour.

### Comparative Example

For this example, instead of a phenolic material in accordance with the present invention, a commercial SMC was used. More specifically a 3 mm thick sheet of Menzolit® SMC 0650 was used.

The process used to form the composite was identical to that used in Example 1.

The resulting composite panel was then used in a test in comparison to those of Examples 1 to 3. More specifically, a brick was placed under the ends of each of the panels so that the panels were raised.

An 8 kg load was placed on each panel and left for a period of 10 minutes, after which time the amount of deflection in the panels was noted.

The results of the test were that the phenolic resin composites of the present invention showed less deflection than that produced using the SMC.

1. An uncured material for forming a phenolic resin sheet comprising:
uncured phenolic resin;
filler;
a catalyst in an amount of less than 2 wt. % relative to the content of phenolic resin; and
wherein the filler is present in a ratio of filler to uncured phenolic resin in an amount of 2.5:1 and greater, and further wherein the filler comprises a transition metal hydroxide and/or aluminium hydroxide in a ratio of metal hydroxide to uncured phenolic resin in an amount of 1:1.5 to 3:1.

2. An uncured material according to claim 1, wherein the catalyst is present in an amount of less than 1 wt. % relative to the content of the uncured phenolic resin.

3. An uncured material according to claim 2, wherein the catalyst is present in an amount of less than 0.5 wt. % relative to the content of the uncured phenolic resin.

4. An uncured material according to claim 3, wherein the catalyst is present in an amount of less than 0.2 wt. %

5. An uncured material according to claim 4, wherein the uncured material is substantially free of catalyst.

6. An uncured material according to claim 5, wherein the uncured material is free of catalyst.

7. An uncured material according to any preceding claim, wherein the filler is present in an amount of 3:1 and greater.

8. An uncured material according to claim 7, wherein the filler is present in an amount of 3.5:1 and greater.

9. An uncured material according to claim 8, wherein the filler is present in an amount of 5:1 and greater.

10. An uncured material according to any preceding claim, wherein the filler is present in an amount of 20:1 and less.

11. An uncured material according to any preceding claim, wherein the phenolic resin is a phenol-formaldehyde resin.

12. An uncured material according to any preceding claim, wherein the filler is a particulate solid which insoluble in the uncured material.

13. An uncured material according to any preceding claim, wherein the filler is inert to the rest of the uncured material.

14. An uncured material according to any preceding claim, wherein the filler is an inorganic material.

15. An uncured material according to any one of claims 1 to 14, wherein the filler is selected from one or more of clays, clay minerals, talc, vermiculite, metal oxides, refractories, solid or hollow glass microspheres, fly ash, coal dust, wood flour, grain flour, nut shell flour, silica, ground plastics and resins in the form of powder, powdered reclaimed waste plastics, powdered resins, pigments, and starches.

16. An uncured material according to any one of the preceding claims, wherein the transition metal or aluminium hydroxides are of formula M(OH)₃, wherein M is a metal.

17. An uncured material according to claim 16, wherein the metal M may be selected from one or more of scandium, vanadium, chromium, manganese, iron, cobalt and aluminium.

18. An uncured material according to any one of the preceding claims, wherein the metal hydroxide is aluminium hydroxide.

19. An uncured material according to any one of the preceding claims, wherein the ratio of metal hydroxide to uncured phenolic resin in an amount of 1:1.6 to 2.5:1.

20. An uncured material according to claim 19, wherein the in a ratio of metal hydroxide to uncured phenolic resin in an amount of 1:2 to 2:1.

21. An uncured material according to any one of claims 15 to 20, wherein the fillers do not substantially comprise silicates and/or carbonates of alkali metals.

22. An uncured material according to any one of claims 15 to 21, wherein the pigment is selected from one or more of metal oxides, powdered paint, rock powders and sand.

23. An uncured material according to any one of the preceding claims, wherein the material further comprises a viscosity controlling agent.

24. An uncured material according to claim 23, wherein the viscosity controlling agent is selected from butanol, chloroform, ethanol, water, acetonitrile, hexane, and isopropyl alcohol.

25. An uncured material according to any preceding claim, wherein the uncured material further comprises fibres.

26. An uncured material according to claim 25, wherein the fibres are woven or unwoven.

27. An uncured material according to any one of claims 25 to 26, wherein the fibres are in the form of a layer.

28. An uncured material according to claim 27, wherein the fibres are in the form of a mat or fabric.

29. An uncured material according to any one of claims 25 to 28, wherein the fibres are selected from one or more of mineral fibres (such as finely chopped glass fibre and finely divided asbestos), chopped fibres, finely chopped natural or synthetic fibres, and ground plastics and resins in the form of fibres.

30. An uncured material according to claim 29, wherein the fibres are selected from one or more of carbon fibres, glass fibres and aramid fibres.

31. An uncured material according to any one of claims 25 to 30, wherein the fibres are added to the uncured material in a ratio of resin to fibre of 6:1 to 1:3.

32. An uncured material according to claim 31, wherein the ratio is from 4:1 to 1:1.

33. A method of forming an uncured phenolic resin sheet comprising:
i. providing an uncured material according to any one of claims 1 to 32; and
ii. shaping the uncured material into a sheet.

34. A method according to claim 33, wherein the step of shaping involves the application of pressure.

35. A method of forming an uncured phenolic resin sheet comprising:
i. providing an uncured material according to any one of claims 1 to 24;
ii. providing fibres according to any one of claims 25 to 32 in the form of a layer; and
iii. applying a layer of the uncured material to the fibres.

36. A method according to claim 35, wherein the step of applying the uncured material further comprises the application of pressure.

37. A uncured phenolic resin sheet produced by a method according to any one of claims 33 to 36.

38. A uncured phenoilic resin sheet produced from an uncured material according to any one of claims 1 to 32.

39. A method of forming a composite product comprising the steps of:
i. providing an uncured phenolic resin material according to any one of claims 1 to 32, or an uncured phenolic resin sheet according to any one of claims 37 to 38;
ii. providing a substrate;
iii. applying a layer of the uncured phenolic resin material or uncured phenolic resin sheet onto a surface of the substrate; and
iv. pressing the layer of the uncured phenolic resin material or uncured phenolic resin sheet to the substrate such that at least a portion of the of the uncured phenolic resin material or uncured phenolic resin sheet bonds to the substrate.

40. A method according to claim 39, further comprising the step of causing or allowing the uncured phenolic resin material or uncured phenolic resin sheet to at least partially set.

41. A method according to claim 40, wherein the step of causing or allowing the uncured phenolic resin material or uncured phenolic resin sheet to at least partially set comprises heating the uncured phenolic resin material or uncured phenolic resin sheet to a suitable temperature.

42. A method according to claim 41, wherein the uncured phenolic resin material or uncured phenolic resin sheet is heated to a temperature of at least 50° C.

43. A method according to claim 41 or 42, wherein the uncured phenolic resin material or uncured phenolic resin sheet is heated to a temperature between 100 and 200° C.

44. A method according any one of claims 39 to 43, wherein the uncured phenolic resin material or uncured phenolic resin sheet is heated for at least one minute.

45. A method according to any one of claims 39 to 44, wherein the substrate is an open-cell foam, and during the pressing step at least a portion of the uncured phenolic resin material or uncured phenolic resin sheet flows into the substrate.

46. A method according to claim 45, wherein the open-cell foam substrate is selected from a foamed phenolic resin or a foamed polyurethane resin.

47. A method according to claim 46, wherein the open-cell foam substrate is a foamed phenolic resin.

48. A method according to any one of claims 39 to 47, wherein the uncured phenolic resin material or uncured phenolic resin sheet is applied to substantially all of the open-cell foam substrate.

49. A method according to any one of claims 39 to 48, wherein the substrate is shaped before the step of pressing the layer of uncured phenolic resin material or uncured phenolic resin sheet to the substrate.

50. A method according to any one of claims 39 to 49, wherein a pressure of at least 400 Pa is applied during pressing.

51. A method according to claim 50, wherein a pressure of between 500 and 7,000 Pa is applied to the uncured phenolic resin material or uncured phenolic resin sheet.

52. A method according to any one of claims 39 to 51, wherein the open-cell foam substrate is a crushable material such that, during the application of pressure, the surface of the substrate is moulded.

53. A product formed by a method according to any one of claims 39 to 52.

54. A product comprising an open-cell foam substrate and a skin of phenolic resin bonded to a surface of the substrate, wherein the phenolic resin is as described in any one of claims 1 to 32.

55. Use of a phenolic resin paste for forming a coloured resin skin, wherein the phenolic resin is as described in any one of claims 1 to 32.

56. Use according to claim 55 wherein the resin skin is white, yellow, pink, red, orange, green, blue or purple.
